(19) United States
(12) Patent Application Publication
(10) Pub. No.: US 2022/0116270 A1
(43) Pub. Date: Apr. 14, 2022

(54) INTERNET OF THINGS CONNECTION SYSTEM, METHOD AND COMPUTER READABLE MEDIUM

(71) Applicant: IoT-EX Inc., Tokyo (JP)

(72) Inventors: Jun MATSUMURA, Tokyo (JP); Yoshihiro OBATA, Tokyo (JP)

(73) Assignee: IoT-EX Inc., Tokyo (JP)

(21) Appl. No.: 17/560,291

(22) Filed: Dec. 23, 2021

Related U.S. Application Data
(63) Continuation of application No. PCT/JP2020/024477, filed on Jun. 22, 2020.

(30) Foreign Application Priority Data
Jun. 27, 2019 (JP) 2019-119447

(51) Int. Cl. H04L 41/0803; H04L 67/12; G06F 9/54

(52) U.S. Cl. CPC H04L 41/0803; G06F 9/541; H04L 67/12

(57) ABSTRACT

An internet of things (IoT) connection system comprises an IoT hub including first processing circuitry, and a local IoT router including second processing circuitry. The local IoT router is connected to the IoT hub via a network. The first processing circuitry is configured to execute a first driver to connect the IoT hub to a private cloud to which a first device is to connect, and execute a second driver to connect the IoT hub to a second device. The second processing circuitry is configured to execute a third driver to connect a third device to the IoT router. The first driver, the second driver and the third driver are generated according to only device definitions and command definitions.

### CROSS-REFERENCE TO RELATED APPLICATIONS

This application is a bypass continuation that claims priority to PCT/JP2020/024477, filed Jun. 22, 2020, which claims priority to JP 2019-119447, filed Jun. 27, 2019, both of which are hereby incorporated by reference in their entirety.

### TECHNICAL FIELD

The present disclosure relates to an Internet of Things (IoT) connection system, an information processing method, and a non-transitory computer readable medium.

### BACKGROUND

Recently, the number of devices that can access the Internet and receive various services has increased. Such devices are called IoT devices.

In general, since such IoT devices are individually connected to dedicated private clouds, IoT devices with different specifications which are manufactured by different makers cannot be connected to the same private cloud.

Recently, an IoT cloud service which is called an IoT hub that can allow IoT devices manufactured by various makers to be connected thereto by publishing an application programming interface (API) for connection to a cloud or providing a software development kit (SDK) or the like has also been provided (such as Non Patent Literature 1 and Non Patent Literature 2).

### SUMMARY

In accordance with the present disclosure, an internet of things (IoT) connection system comprises an IoT hub including first processing circuitry, and a local IoT router including second processing circuitry. The local IoT router is connected to the IoT hub via a network. The first processing circuitry is configured to execute a first driver to connect the IoT hub to a private cloud to which a first device is to connect, and execute a second driver to connect the IoT hub to a second device. The second processing circuitry is configured to execute a third driver to connect a third device to the IoT router. The first driver, the second driver and the third driver are generated according to only device definitions and command definitions.

### BRIEF DESCRIPTION OF THE DRAWINGS

FIG. 1 is a system configuration diagram illustrating an example of a configuration of an IoT connection system according to an embodiment.

FIG. 2 is a diagram illustrating an example of a plurality of private clouds in the IoT connection system according to the embodiment.

FIG. 3 is a diagram illustrating an example of a plurality of first devices which are connected to private clouds in the IoT connection system according to the embodiment.

FIG. 4 is a diagram illustrating an example of a flow of a service which is provided by the IoT connection system according to the embodiment.

FIG. 5 is a diagram illustrating an example of a flow of a service which is provided by the IoT connection system according to the embodiment.

FIG. 6 is a diagram illustrating another example of a flow of a service which is provided by the IoT connection system according to the embodiment.

FIG. 7 is a diagram illustrating an example of a flow of a virtual driver function which is provided by the IoT connection system according to the embodiment.

FIG. 8 is a diagram illustrating another example of a flow of a virtual driver function which is provided by the IoT connection system according to the embodiment.

FIG. 9 is a flowchart illustrating an example of a flow of an information processing method according to an embodiment.

FIG. 10 is a block diagram of processing circuitry that performs computer-based operations in accordance with the present disclosure.

### DETAILED DESCRIPTION OF THE DRAWINGS

Although the aforementioned IoT cloud services exist, cooperation between the services is limited and makers of IoT devices need to develop dedicated connection programs which differ depending on the services and incorporate the programs into the devices. The inventors of the present disclosure have recognized this issue and developed technology that provides an attractive service by freely mutually connecting existing IoT devices in a silo state for each private cloud via the Internet.

An IoT connection system according to the disclosure is an IoT connection system including an IoT hub that is realized over a cloud and a local IoT router that is connected to the IoT hub, characterized in that the IoT hub includes a first driver configured to connect the IoT hub to a private cloud to which a first device is able to be connected and a second driver configured to connect the IoT hub to a second device, the IoT router includes a third driver configured to connect a third device to the IoT router, and information which a user is to describe to create the first driver, the second driver, and the third driver is limited to information on device definitions and command definitions.

At least one of the first driver, the second driver, and the third driver may realize a virtual device function of virtually reproducing the first device, the second device, or the third device.

The IoT hub may realize a directory function of causing the first device, the second device, the third device, and an IoT service available via the IoT hub to cooperate with each other.

The directory function may identify the first device, the second device, the third device, or the IoT service and give an instruction to the first device, the second device, the third device, or the IoT service.

The IoT hub may include a Web API for use of an IoT application.

Information which is acquired from the first device, the second device, or the third device may not be stored in the IoT hub.

A non-transitory computer readable medium may store computer-executable instructions which, when executed by a device in an IoT connection system including an IoT hub that is realized over a cloud and a local IoT router that is connected to the IoT hub, to perform: a connection function of connecting a private cloud to which one or more devices are able to be connected and the IoT hub, the device and the IoT hub, or the device and the IoT router; a storage function of storing information on device definitions and command definitions described by a user; a reception function of receiving a command for the device; an operation function of operating the device on the basis of the information stored by the storage function and the command received by the reception function; and a processing function of performing a pre-process of collecting result data of an operation based on the operation function.

An information processing method according to the disclosure is an information processing method that is performed by one or more computer processors in an IoT connection system including an IoT hub that is realized over a cloud and a local IoT router that is connected to the IoT hub, the information processing method including: a connection step of connecting a private cloud to which one or more devices are able to be connected and the IoT hub, the device and the IoT hub, or the device and the IoT router; a reception step of receiving a command for the device; an operation step of operating the device on the basis of information on device definitions and command definitions described by a user and the command received in the reception step; and a processing step of performing a pre-process of collecting result data of an operation in the operation step.

According to the disclosure, it is possible to provide an attractive service by freely mutually connecting existing IoT devices in a silo state for each private cloud via the Internet.

Specifically, according to the disclosure, it is possible to easily mutually connect IoT devices connected to existing private clouds as well as those directly connected IoT devices.

According to the disclosure, it is possible to flexibly and easily connect various types of IoT devices.

Hereinafter, an IoT connection system according to an embodiment of the disclosure will be described with reference to the accompanying drawings.

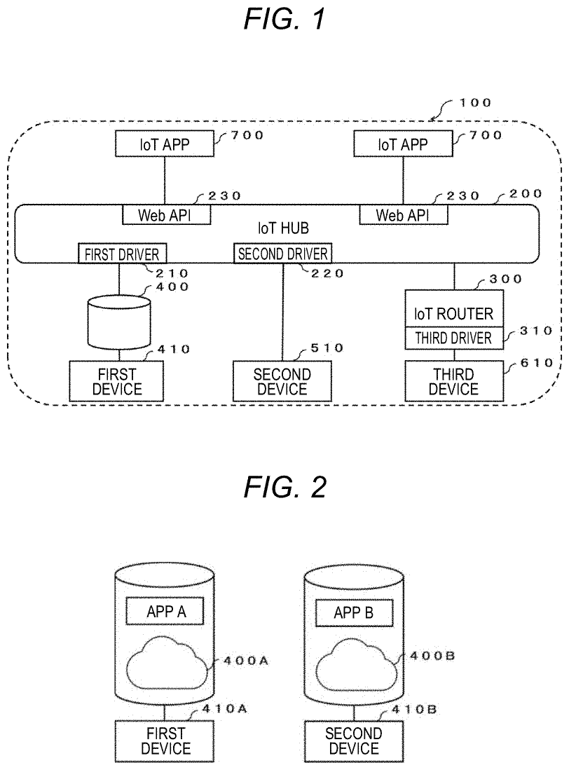

As illustrated in FIG. 1, an IoT connection system 100 includes an IoT hub 200 and an IoT router 300.

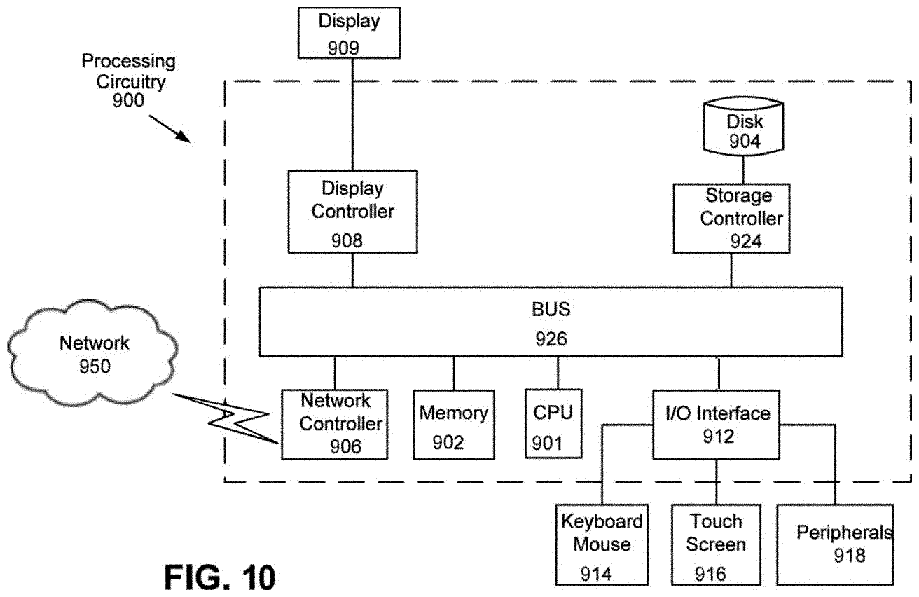

The IoT hub 200 is realized over a cloud. Specifically, the IoT hub 200 is a managed service hosted in a cloud and serves as a relay for bidirectional communication between an IoT application (hereinafter referred to as an “IoT app”) and an IoT device. In an exemplary implementation, a server including processing circuitry executes the functionality of IoT hub 200 and performs bidirectional communication between the IoT app and the IoT device. Detailed discussion of processing circuitry will be provided later with respect to FIG. 10.

The IoT router 300 is local and is connected to the IoT hub 200 by a wide area network (WAN).

Specifically, the IoT router 300 serves to realize connection of an IoT device that is not connected to the Internet, such as an in-house network, to the IoT hub 200. In an exemplary implementation, IoT router includes processing circuitry as will be discussed later with respect to FIG. 10.

The IoT hub 200 includes a first driver 210 and a second driver 220.

The first driver 210 and the second driver 220 serve to absorb a difference in specifications between makers of IoT devices.

The first driver 210 serves to connect a private cloud 400 to which a first device 410 is able to be connected to the IoT hub 200.

For example, it is preferable that the first device 410 and the private cloud 400 be connected by a local area network (LAN) and the private cloud 400 and the first driver 210 be connected by a WAN.

The private cloud 400 is provided by a provider of the first device 410. The number of private clouds 400 in FIG. 1 is one, but it is not limited thereto and a plurality of private clouds 400 may be connected to the IoT hub 200. The IoT hub 200 may include a plurality of first drivers 210.

FIG. 2 illustrates details of two private clouds 400A and 400B which are provided by different providers A and B. As illustrated in FIG. 2, the private cloud 400A is connected to an application A (hereinafter referred to as “app A”) which is provided by a provider A and provides a service based on the app A to a first device 410A.

Similarly, the private cloud 400B is connected to an application B (hereinafter referred to as “app B”) which is provided by a provider B and provides a service based on the app B to a first device 410B.

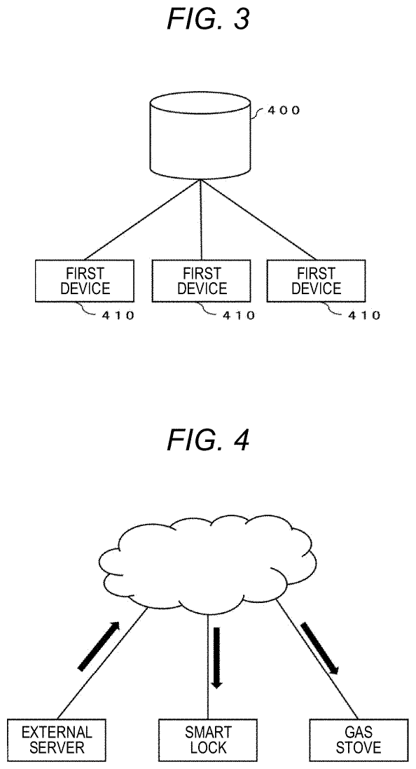

FIGS. 1 and 2 illustrate examples in which only one first device 410 is connected to one private cloud 400, but a plurality of first devices 410 may be connected to one private cloud 400 as illustrated in FIG. 3.

The first device 410 may be a device for which a private cloud is provided by a provider. Examples thereof include an electronic lock having a remote lock function, an AI speaker, and a nursing bed which is able to be remotely operated, but the first device is not particularly limited thereto.

The second driver 220 serves to directly connect a second device 510 to the IoT hub 200.

For example, it is preferable that the second device 510 and the second driver 220 be connected by a LAN.

FIG. 1 illustrates an example in which only one second device 510 is connected to the second driver 220, but a plurality of second devices 510 may be connected to one second driver 220. The IoT hub 200 may include a plurality of second drivers 220.

The second device 510 may be a device for which a private cloud is not provided by a provider. Examples thereof include a fan, an air conditioner, a window, a curtain, and a light, but the second device is not particularly limited thereto.

The IoT router 300 includes a third driver 310. The IoT router 300 may include a plurality of third drivers 310.

The third driver 310 serves to connect a third device 610 to the IoT router 300.

For example, it is preferable that the third device 610 and the third driver 310 be connected by a LAN and the IoT router 300 and the IoT hub 200 be connected by a WAN.

As described above, the third device 610 may be an IoT device which is not connected to the Internet such as an in-house network. The third device 610 may be a device which should not be directly connected to the IoT hub 200 from a point of view of security, privacy, and safety. Examples thereof include a gas stove, a face authentication device, and a sensor information collection data logger, but the third device is not particularly limited thereto.

In this way, the IoT connection system 100 is a hybrid type IoT connection system that connects some devices to a local IoT router 300 instead of directly connecting all devices to the IoT hub 200 in a cloud.

With this configuration, it is possible to easily mutually connect IoT devices connected to an existing private cloud as well as IoT devices which are directly connected.

Accordingly, unlike the related art in which only IoT devices of predetermined makers are connected, it is possible to easily mutually connect IoT devices of various makers. By mutually connecting IoT devices of various makers, it is possible to provide a unique service which was not provided in the related art.

For example, with the IoT connection system 100, when emergency earthquake news is received from an external server as illustrated in FIG. 4, it is possible to easily realize a service of transmitting a flameout signal to a gas stove and unlocking a front door.

In the IoT connection system 100, information which a user should describe to create the first driver 210, the second driver 220, and the third driver 310 is limited to information on device definitions and command definitions.

A method of creating the first driver 210, the second driver 220, and the third driver 310 will be described below. A creator may be a user associated with manufacturing and development of IoT devices or a user associated with provision of the IoT connection system 100.

Regarding the first driver 210, the second driver 220, and the third driver 310, information of the same details can be described, and it may be described in different programming languages.

First, a creator defines an available device list as device definitions. For example, when a “weather sensor,” an “indoor sensor,” an “outdoor sensor,” a “suspicious person sensor,” an “approval sensor,” and a “power sensor” are defined as available devices, names thereof and “weather,” “inhouse,” “outdoor,” “security,” “approve,” and “power” which are IDs thereof are described.

Subsequently, the creator defines available commands as command definitions. For example, when available commands for the “outdoor sensor” are defined, an observation command for a sensor value is described. Examples of the observation command include “observe,” “get,” and “observe outdoors.”

By causing a creator to embed such information on device definitions and command definitions in a program in a hole filling manner, the first driver 210, the second driver 220, and the third driver 310 can be completed. The other parts can be provided as an SDK from a provider.

The SDK part includes a part associated with a device operation process in the received command, a part associated with a pre-process of the collected sensor data/operation result data, and a part associated with a process of transmitting data to the IoT hub.

With this configuration, since drivers for various types of IoT devices can be simply completed, it is possible to realize an IoT connection system that can flexibly and easily connect IoT devices.

In general, the technical field of engineers associated with device development is different from that of engineers for Web development and many engineers for device development do not have the technical expertise to connect devices to an IoT hub.

Accordingly, as in the disclosure, it is very profitable for any driver program to be able to be created using a simple method in a common hole plugging manner. Accordingly, it is possible to reduce development costs or development periods associated with connection of an IoT device to an IoT hub in comparison with those in the related art.

Even when there is a difference in allowable costs like a fan and an air conditioner, it is possible to equally realize connection thereof to an IoT hub through a decrease in development cost.

Connection between an IoT hub 200 and an IoT app associated with the IoT connection system 100 will be described below.

As illustrated in FIG. 1, an IoT hub 200 may include a Web API 230 for use of an IoT application 700. As illustrated in FIG. 1, IoT applications 700 corresponding to the number of services can be connected and each can be connected using a Web API 230.

Each IoT application 700 is created by describing a data acquisition logic from an IoT device (sensor) and/or an operation logic of the IoT devices in an application.

The data acquisition logic includes a part for pre-processing the acquired sensor data and a part for performing transmission to an API of the IoT hub 200. Information used includes a destination URL which is provided by a provider of the IoT connection system 100, an API key which is provided by a provider, device information, and an execution command.

The device operation logic includes a part for pre-processing a command for a device to be operated and a part for performing transmission to an API of the IoT hub 200. Information used includes a destination URL which is provided by the provider of the IoT connection system 100, an API key which is provided by the provider, device information, and an execution command.

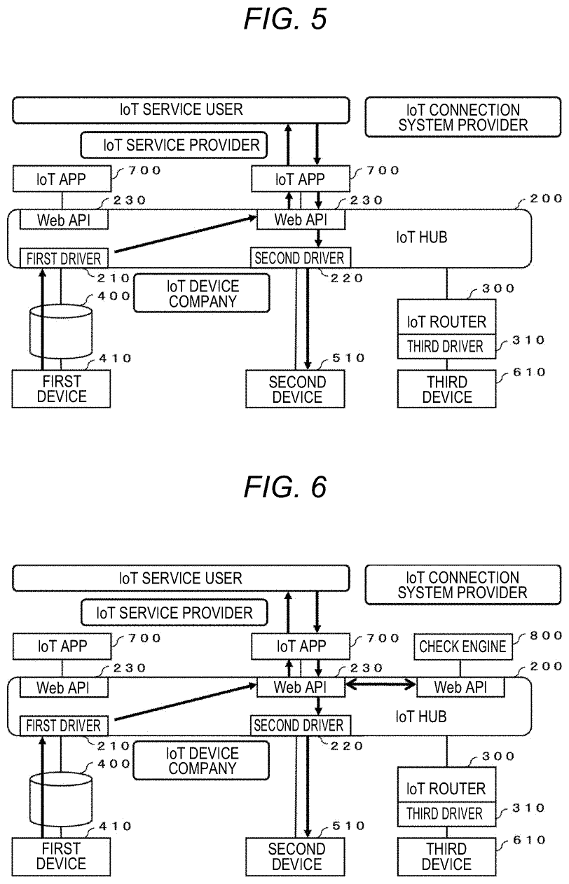

FIG. 5 is a diagram illustrating a flow in which an IoT service user (an end user) is provided with an IoT service from an IoT service provider using an IoT device which is provided by the IoT service provider. As illustrated in FIG. 5, when an event is first transmitted from a first device 410, the end user is notified of the event via the private cloud 400, the first driver 210, the Web API 230, and the IoT application 700.

Subsequently, when the end user determines an action, the second device 510 is instructed to execute the action via the IoT application 700, the Web API 230, and the second driver 220.

Cooperation between IoT devices can be expressed by an event-driving program such as “OO, if ˜.” This process can be made into a component as a micro service, can be communized for use, and can be mounted as a function as a service (FaaS) function.

As illustrated in FIG. 6, the IoT hub 200 can be connected to a check engine 800. The check engine 800 serves to check details of which a device is instructed by the IoT hub 200 and to prevent an inappropriate action from being executed.

For example, when an IoT service, “an air conditioner is stopped and a window is opened if outside air is fair,” is provided, the inside may get wet if an unexpected rainstorm strikes immediately after, and the check engine 800 serves to prevent such a threat derived from an IoT service.

At least one of the first driver 210, the second driver 220, and the third driver 310 can realize a virtual device function.

The virtual device function is for virtually reproducing the first device 410, the second device 510, or the third device 610.

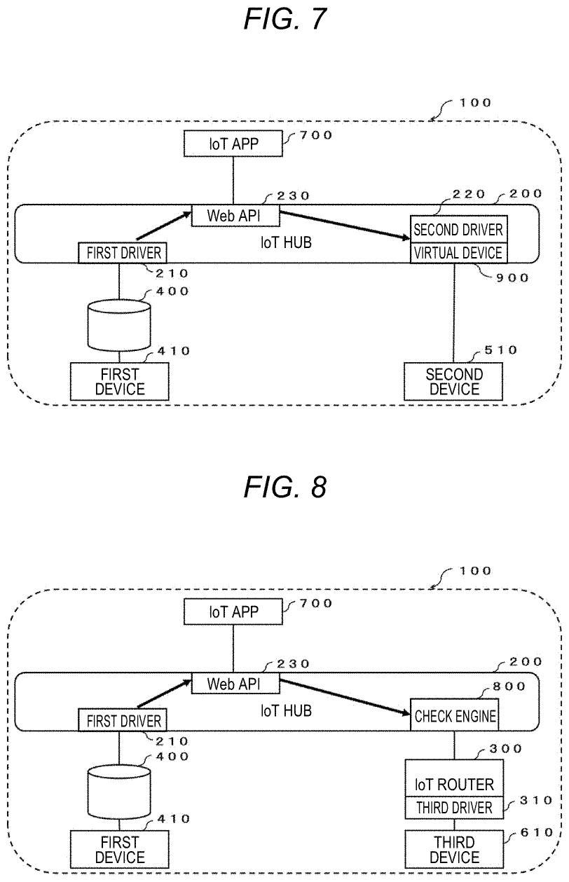

FIG. 7 illustrates an example in which the second driver 220 realizes the virtual device function. As illustrated in FIG. 7, by providing a virtual device 900 that can reproduce transmission and reception of a command for the second device 510 in the second driver 220, it is possible to develop an IoT application using the second device 510 even when the second device 510 is not connected. When an operation failure occurs, it is possible to easily perform failure identification of determining which of the second device 510 and the IoT hub 200 is out of order without visiting the spot.

According to the disclosure, the IoT hub 200 may realize the virtual device function instead of a driver as illustrated in FIG. 8. This is effective for failure identification of the third device 610 connected to the local IoT router 300.

The IoT hub 200 in the IoT connection system 100 can realize a directory function.

The directory function is for causing the first device 410, the second device 510, and the third device 610 to cooperate with an IoT service which can be used via the IoT hub 200.

That is, the directory function is for realizing a function of identifying objects or services such that a path from an object (device) to a service, from a service to an object, and from an object to an object can be ascertained and providing instructions to the objects or the services.

Specifically, the directory function can identify the first device 410, the second device 510, or the third device 610 or the IoT service or provide instructions to the first device 410, the second device 510, or the third device 610 or the IoT service.

In the IoT connection system 100, information acquired from the first device 410, the second device 510, or the third device 610 may not be stored in the IoT hub 200.

It is supposed that the IoT connection system 100 is run by a telecommunications carrier. A telecommunications carrier has an obligation to keep communication secrets, and thus does not store information acquired from various devices for other purposes of utilization.

Since such information is valuable information, an IoT device is generally enclosed in a private cloud of each carrier in order to exclusively acquire such information.

On the other hand, with the IoT connection system 100, since it is run by a telecommunications carrier, it is possible to mutually connect IoT devices and IoT applications at a neutral position and to promote IoT business.

Since continuity of an IoT mutual connection service affects continuity of an IoT service of a corporation using the IoT mutual connection service, it is preferable that the corporation share a mutual connection infrastructure.

In the IoT connection system 100, only devices or IoT applications which are permitted using an API key and an authentication scheme can be connected to the IoT hub 200. That is, the IoT connection system 100 can construct a closed network dedicated for IoT communication over the Internet. Since communication paths are encrypted and IoT routers are managed by mobile device management (MDM), it is also possible to cope with new attacks or weaknesses of an OS or application.

When it is intended to connect non-IoT devices to the IoT hub 200, it is possible to perform development in a short time by utilizing backend as a service (BaaS) or SDK.

The provider of the IoT connection system 100 can propose a mutual connection support service of an IoT device. Specifically, it is possible to provide business matching and consulting services. That is, in order to provide added value, it is possible to search for opponents and to perform introduction of value creation patterns and best practices thereto or the like.

It is possible to create an attractive service by combination with devices or applications of other providers and to expand business by bringing added value.

Computer executable instructions stored in a non-transitory computer readable medium for execution by processing circuitry will be described below.

The computer-executable instructions, when executed by one or more computer processors in an IoT connection system including an IoT hub that is realized over a cloud and a local IoT router that is connected to the IoT hub, are caused to perform a connection function, a storage function, a reception function, an operation function, and a processing function.

The connection function is for connecting a private cloud to which one or more devices are able to be connected or the one or more devices and the IoT hub. The connection function can be realized by the first driver 210, the second driver 220, or the third driver 310. Details of the first driver 210, the second driver 220, or the third driver 310 are the same as described above.

The storage function is for storing information on device definitions and command definitions described by a user. The storage function can be realized by the first driver 210, the second driver 220, or the third driver 310. Details of the first driver 210, the second driver 220, or the third driver 310 are the same as described above.

The reception function is for receiving a command for the device. The reception function can be realized by the first driver 210, the second driver 220, or the third driver 310. Details of t the first driver 210, the second driver 220, or the third driver 310 are the same as described above.

The operation function is for operating the device on the basis of the information stored by the storage function and the command received by the reception function. The operation function can be realized by the first driver 210, the second driver 220, or the third driver 310. Details of the first driver 210, the second driver 220, or the third driver 310 are the same as described above.

The processing function is for and performing a pre-process of collecting the result data of an operation based on the operation function. The processing function can be realized by the first driver 210, the second driver 220, or the third driver 310. Details of the first driver 210, the second driver 220, or the third driver 310 are the same as described above.

With this configuration, it is possible to easily mutually connect IoT devices connected to an existing private cloud as well as IoT devices which are directly connected.

With this configuration, it is possible to flexibly and easily connect various types of IoT devices.

An information processing method according to an embodiment of the disclosure will be finally described below with reference to the accompanying drawings.

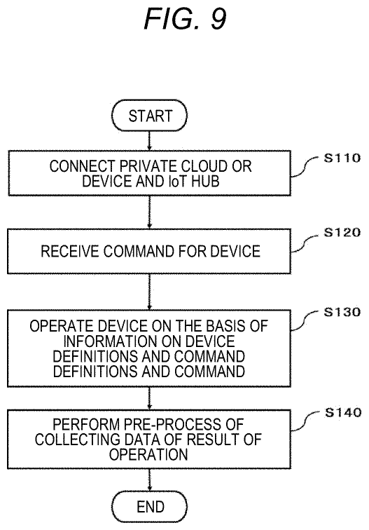

As illustrated in FIG. 9, the information processing method according to the disclosure causes one or more computer processors in an IoT connection system including an IoT hub that is realized over a cloud and a local IoT router that is connected to the IoT hub to perform a connection step S110, a reception step S120, an operation step S130, and a processing step S140.

The connection step 5110 is for connecting a private cloud to which one or more devices are able to be connected or the one or more devices and the IoT hub. The connection step S110 can be realized by the first driver 210, the second driver 220, or the third driver 310. Details of the first driver 210, the second driver 220, or the third driver 310 are the same as described above.

The reception step S120 is for receiving a command for the device. The reception Step S120 can be realized by the first driver 210, the second driver 220, or the third driver 310. Details of the first driver 210, the second driver 220, or the third driver 310 are the same as described above.

The operation step S130 is for operating the device on the basis of information on device definitions and command definitions described by a user and the command received by the reception step. The operation step 5130 can be realized by the first driver 210, the second driver 220, or the third driver 310. Details of the first driver 210, the second driver 220, or the third driver 310 are the same as described above.

The processing step S140 is for performing a pre-process of collecting the result data of an operation based on an operation step. The processing step 5140 can be realized by the first driver 210, the second driver 220, or the third driver 310. Details of the first driver 210, the second driver 220, or the third driver 310 are the same as described above.

With this configuration, it is possible to easily mutually connect IoT devices connected to an existing private cloud as well as IoT devices which are directly connected.

With this configuration, it is possible to flexibly and easily connect various types of IoT devices.

While some embodiments of the disclosure have been described above, the embodiments are merely presented as examples and are not intended to limit the scope of the disclosure. The embodiments can be embodied in various other forms and can be subjected to various omissions, substitutions, and alterations without departing from the gist of the disclosure. The embodiments or modifications thereof belong to the scope or gist of the disclosure and also belong to the disclosures described in the appended claims and a scope equivalent thereto.

FIG. 10 is a block diagram of processing circuitry that performs computer-based operations in accordance with the present disclosure. FIG. 10 illustrates processing circuitry 900 of components of IoT connection system 100.

Processing circuitry 900 is used to control any computer-based and cloud-based control processes, descriptions or blocks in flowcharts can be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The functionality of the elements disclosed herein may be implemented using circuitry or processing circuitry which may include general purpose processors, special purpose processors, integrated circuits, ASICs (“Application Specific Integrated Circuits”), conventional circuitry and/or combinations thereof which are configured or programmed to perform the disclosed functionality. Processors are processing circuitry or circuitry as they include transistors and other circuitry therein. The processor may be a programmed processor which executes a program stored in a memory. In the disclosure, the processing circuitry, units, or means are hardware that carry out or are programmed to perform the recited functionality. The hardware may be any hardware disclosed herein or otherwise known which is programmed or configured to carry out the recited functionality.

In FIG. 10, the processing circuitry 900 includes a CPU 901 which performs one or more of the control processes discussed in this disclosure. The process data and instructions may be stored in memory 902. These processes and instructions may also be stored on a storage medium disk 904 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other non-transitory computer readable medium of an information processing device with which the processing circuitry 900 communicates, such as a server or computer. The processes may also be stored in network based storage, cloud-based storage or other mobile accessible storage and executable by processing circuitry 900.

Further, the claimed advancements may be provided as a utility application, background daemon, or component of an operating system, or combination thereof, executing in conjunction with CPU 901 and an operating system such as Microsoft Windows, UNIX, Solaris, LINUX, Apple MAC-OS, Apple iOS and other systems known to those skilled in the art.

The hardware elements in order to achieve the processing circuitry 900 may be realized by various circuitry elements. Further, each of the functions of the above described embodiments may be implemented by circuitry, which includes one or more processing circuits. A processing circuit includes a particularly programmed processor, for example, processor (CPU) 901, as shown in FIG. 10. A processing circuit also includes devices such as an application specific integrated circuit (ASIC) and conventional circuit components arranged to perform the recited functions.

In FIG. 10, the processing circuitry 900 may be a computer or a particular, special-purpose machine. Processing circuitry 900 is programmed to execute processing to control components of IoT connection system 100.

Alternatively, or additionally, the CPU 901 may be implemented on an FPGA, ASIC, PLD or using discrete logic circuits, as one of ordinary skill in the art would recognize. Further, CPU 901 may be implemented as multiple processors cooperatively working in parallel to perform the instructions of the inventive processes described above.

The processing circuitry 900 in FIG. 10 also includes a network controller 906, such as an Ethernet PRO network interface card, for interfacing with network 950. As can be appreciated, the network 950 can be a public network, such as the Internet, or a private network such as LAN or WAN, or any combination thereof and can also include Public Switched Telephone Network (PSTN) or Integrated Services Digital Network (ISDN) sub-networks. The network 950 can also be wired, such as an Ethernet network, universal serial bus (USB) cable, or can be wireless such as a cellular network including EDGE, 3G and 4G wireless cellular systems. The wireless network can also be Wi-Fi, wireless LAN, Bluetooth, or any other wireless form of communication that is known. Additionally, network controller 906 may be compliant with other direct communication standards, such as Bluetooth, a near field communication (NFC), infrared ray or other.

The processing circuitry 900 further includes a display controller 908, such as a graphics card or graphics adaptor for interfacing with display 909, such as a monitor. An I/O interface 912 interfaces with a keyboard and/or mouse 914 as well as a touch screen panel 916 on or separate from display 909. I/O interface 912 also connects to a variety of peripherals 918.

The storage controller 924 connects the storage medium disk 904 with communication bus 926, which may be an ISA, EISA, VESA, PCI, or similar, for interconnecting all of the components of the processing circuitry 900. A description of the general features and functionality of the display 909, keyboard and/or mouse 914, as well as the display controller 908, storage controller 924, network controller 906, and I/O interface 912 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

### REFERENCE SIGNS LIST

100 IoT connection system
200 IoT hub
210 First driver
220 Second driver
230 Web API
300 IoT router
310 Third driver
400 Private cloud
410 First device
510 Second device
610 Third device
700 IoT app
800 Check engine
900 Processing circuitry

1. An internet of things (IoT) connection system, comprising:
an IoT hub including first processing circuitry; and
a local IoT router including second processing circuitry, wherein
the local IoT router is connected to the IoT hub via a network,
the first processing circuitry is configured to
execute a first driver to connect the IoT hub to a private cloud to which a first device is to connect, and
execute a second driver to connect the IoT hub to a second device,
the second processing circuitry is configured to execute a third driver to connect a third device to the IoT router, and
the first driver, the second driver and the third driver are generated according to only device definitions and command definitions.

2. The IoT connection system according to claim 1, wherein execution of at least one of the first driver, the second driver, and the third driver includes executing a virtual device function of virtually reproducing the corresponding first device, second device, or third device.

3. The IoT connection system according to claim 1, wherein the first processing circuitry is further configured to execute a directory function to enable the first device, the second device, the third device, and an IoT service available via the IoT hub to cooperate with each other.

4. The IoT connection system according to claim 3, wherein the directory function identifies the first device, the second device, the third device, or the IoT service and provides an instruction to the first device, the second device, the third device, or the IoT service.

5. The IoT connection system according to claim 1, wherein the IoT hub includes a Web API for use of an IoT application.

6. The IoT connection system according to claim 1, wherein information which is acquired from the first device, the second device, or the third device is not stored in the IoT hub.

7. The IoT connection system according to claim 2, wherein the first processing circuitry is further configured to execute a directory function to enable the first device, the second device, the third device, and an IoT service available via the IoT hub to cooperate with each other.

8. The IoT connection system according to claim 7, wherein the directory function identifies the first device, the second device, the third device, or the IoT service and provides an instruction to the first device, the second device, the third device, or the IoT service.

9. The IoT connection system according to claim 1, wherein the first processing circuitry is further configured to store the device definitions and the command definitions in a memory.

10. The IoT connection system according to claim 9, wherein the first processing circuitry is further configured to receive a command from the first device.

11. The IoT connection system according to claim 10, wherein the first processing circuitry is further configured to control operation of the first device based on the device definitions, the command definitions and the command.

12. The IoT connection system according to claim 11, wherein the first processing circuitry is further configured to collect result data of the operation.

13. The IoT connection system according to claim 12, wherein the first processing circuitry is further configured to perform a pre-process of the result data.

14. A non-transitory computer readable medium storing computer executable instructions which, when executed by processing circuitry provided in an Internet of Things (IoT) hub of an IoT connection system including the IoT hub and a local IoT router connected to the IoT hub via a network, cause the processing circuitry to:
connect to a private cloud to which a device is to connect;
store device definitions and command definitions described by a user;
receive a command for the device;
control operation of the device based on the information and the command;
collect result data of the operation; and
perform a pre-process of the result data.

15. An information processing method that is performed by processing circuitry provided in an Internet of Things (IoT hub) of an IoT connection system including an IoT hub and a local IoT router connected to the IoT hub via a network, the information processing method comprising:
connecting to a private cloud to which a device is to connect;
receiving a command for the device;
controlling operation of the device based on only device definitions and command definitions and the command;
collecting result data of the operation; and
performing a pre-process of the result data.

16. The information processing method according to claim 15, further comprising storing the device definitions and the command definitions in a memory.

17. The information processing method according to claim 15, further comprising executing a virtual device function of virtually reproducing the device.

18. The information processing method according to claim 15, further comprising executing a directory function to enable the device and an IoT service available via the IoT hub to cooperate with each other.

19. The information processing method according to claim 18, wherein the directory function identifies the device or the IoT service and provides an instruction to the device or the IoT service.

20. The information processing method according to claim 15, wherein the IoT hub includes a Web API for use of an IoT application.
